(19) United States
(12) Patent Application Publication
(10) Pub. No.: US 2023/0223803 A1
(43) Pub. Date: Jul. 13, 2023

(54) ROTOR STRUCTURE WITH SUPPRESS HARMONIC SUBSTRUCTURE

(71) Applicant: TECO Electric & Machinery Co., Ltd., TAIPEI CITY (TW)

(72) Inventors: Lian-Shin HUNG, TAIPEI CITY (TW); Ching-Chih HUANG, TAIPEI CITY (TW)

(21) Appl. No.: 17/573,037

(22) Filed: Jan. 11, 2022

(51) Int. Cl. H02K 1/276

(52) U.S. Cl. CPC H02K 1/276; H02K 29/03

(57) ABSTRACT

A rotor structure with a suppress harmonic substructure includes a rotor body furnished with magnet-setting areas surrounding a circular center and magnets disposed individually in rotor body. Each magnet-setting area has first and second magnet slots, extended obliquely and symmetrically to a radial axis of the circular center. Outer ends of the first and second magnet slot are disposed adjacent to the radial axis and a rotor's outer rim of the rotor body, and inner ends of the first and second magnet slots are disposed away from the radial axis and the rotor's outer rim. The rotor's outer rim is furnished with main cavities, first and second auxiliary cavities. The radial axis corresponding to one magnet-setting area penetrates through the corresponding one main cavity, and one first auxiliary cavity and one second auxiliary cavity in the same magnet-setting area are disposed to opposite sides of the corresponding main cavity.

### BACKGROUND OF THE INVENTION

### (1) Field of the Invention

The invention relates to a rotor structure, and more particularly to a rotor structure with a suppress harmonic substructure.

### (2) Description of the Prior Art

Refer to FIG. 1 and FIG. 2; where FIG. 1 is a schematic planar view of a conventional permanent magnet motor structure, and FIG. 2 is an enlarged view of circle A of FIG. 1. As shown, the permanent magnet motor structure PA100 includes a stator structure PA1 and a rotor structure PA2 disposed inside the stator structure PAL The rotor structure PA2 includes a rotor body PA21 and a plurality of magnets PA22 mounted individually into corresponding magnet-disposed holes (not shown in the figure) at the rotor body PA21. In particular, the plurality of magnets PA22 are arranged into V-shaped pairs so as to collect magnets PA22 with the same polarity for effectively generating a magnetic field with enhanced magnetic forcing.

Referring to FIG. 3, a schematic perspective view of another conventional permanent magnet motor is shown, in which the aforesaid V-shaped pairs of the magnets PA22 are particularly adopted. The rotor PA200 of the conventional permanent magnet motor has oppositely a first end surface PA201 and a second end surface PA202, and is furnished with a plurality of magnets (only PA300, PA400, PA500 and PA600 shown in the figure) arranged into the aforesaid V-shaped pairs, in which the first end PA301 of the magnet PA300 and the first end PA401 of the magnet PA400 are magnetic poles with the same polarity, while the first end PA501 of the magnet PA500 and the first end PA601 of the magnet PA600 are also magnetic poles with the same polarity. However, the magnetic polarity of the magnets PA500 and PA600 are opposite to that of the magnets PA300 and PA400.

For example, the magnetic polarity of the first ends PA301 and PA401 can be an S pole, while that of the second ends PA302 and PA402 is an N pole. Contrarily, if the first ends PA501 and PA601 are both N poles, then the second ends PA502 and PA602 are both S poles. Thus, according to the arrangement of V-shaped pairs generally adopted by the rotor PA200 of the conventional permanent magnet motor, the two magnets PA300 and PA400 are collected as a pair, and the other two magnets PA500 and PA600 are collected as another pair with the polarity different to the previous pair. As such, all the magnets (including at least PA300, PA400, PA500 and PA600) of the rotor PA200 of the conventional permanent magnet motor) are arranged into pairs with alternating N-pole and P-pole pairs.

As described above, though the conventional permanent magnet motor can implement the magnet arrangement of V-shaped pairs to enhance magnetic forcing, yet, at the moment when the permanent magnet motor is operated right to have the poles of coils at the stator to attract those of the magnets at the rotor, the retard to the rotation of the rotor by the attractive forcing would make worse even more by the resulted cogging torque formed in between.

### SUMMARY OF THE INVENTION

Due to the cogging torque phenomenon at the conventional permanent magnet motor equipped with the V-shaped pairs of magnets to enhance magnetic forcing, it is inevitable that the rotation of the rotor would be severely retarded. Accordingly, it is an object of the present invention to provide an improved rotor structure that can reduce the cogging torque in rotation through a structural modification.

In the present invention, a rotor structure with a suppress harmonic substructure includes a rotor body and a plurality of magnets.

The rotor body is furnished with a plurality of magnet-setting areas to surround a circular center. Each of the plurality of magnet-setting areas has a first magnet slot and a second magnet slot, in which the first magnet slot and the second magnet slot are extended obliquely and symmetrically with respect to a radial axis passing through the circular center. A first outer end of the first magnet slot and a second outer end of the second magnet slot are both disposed adjacent to the radial axis and a rotor's outer rim of the rotor body, and a first inner end of the first magnet slot and a second inner end of the second magnet slot are both disposed away from the radial axis and the rotor's outer rim. The rotor's outer rim is furnished with a plurality of main cavities, a plurality of first auxiliary cavities and a plurality of second auxiliary cavities. The radial axis corresponding to one of the plurality of magnet-setting areas penetrates through corresponding one of the plurality of main cavities, and one of the plurality of first auxiliary cavities and one of the plurality of second auxiliary cavities in the one of the plurality of magnet-setting areas are disposed to opposite sides of the corresponding one of the plurality of main cavities.

The plurality of magnets are disposed individually in the first magnet slots and the second magnet slots of the plurality of magnet-setting areas.

In one embodiment of the present invention, each of the plurality of first auxiliary cavity includes a first convex corner adjacent to the radial axis, a second convex corner away from the radial axis, and a concave portion disposed between the first convex corner and the second convex corner.

Preferably, the first convex corner has a radius of curvature of 0.3 mm, the second convex corner has a radius of curvature of 5 mm, and the concave portion has a radius of curvature of 1 mm.

In addition, a first connecting segment is disposed between the first convex corner and the concave portion, a second connecting segment is disposed between the second convex corner and the concave portion, and the first connecting segment and the second connecting segment form an angle of 83°.

In one embodiment of the present invention, each of the plurality of main cavities includes a central arc segment and two round corner edges, the radial axis penetrates through the central arc segment, and the two round corner edges are disposed to opposite sides of the central arc segment.

Preferably, the central arc segment has a radius of curvature of 5 mm, each of the two round corner edges has a radius of curvature of 5 mm, and each of the plurality of main cavities further includes two straight connecting segments extending individually to connect the two round corner edges, respectively, from the central arc segment.

In addition, the two straight connecting segments form an opening angle between 50° and 70°; preferably, 62°.

As stated, the rotor structure with a suppress harmonic substructure according to this invention provides a plurality of main cavities, a plurality of first auxiliary cavities and a plurality of second auxiliary cavities to the rotor's outer rim, such that, while the rotor structure rotates, the magnetic fields of the magnets in the first magnet slots and the second magnet slots can be effectively extending to the stator, and so the operational cogging torque can be greatly reduced. Namely, with the rotor structure with a suppress harmonic substructure of the invention to equip the permanent magnet motor, the associated operation efficiency can be effectively enhanced.

All these objects are achieved by the rotor structure with suppress harmonic substructure described below.

### BRIEF DESCRIPTION OF THE DRAWINGS

The present invention will now be specified with reference to its preferred embodiment illustrated in the drawings, in which:

FIG. 1 is a schematic planar view of a conventional permanent magnet motor structure;

FIG. 2 is an enlarged view of circle A of FIG. 1;

FIG. 3 is a schematic perspective view of another conventional permanent magnet motor;

FIG. 4 is a schematic planar view of a preferred embodiment of the rotor structure with a suppress harmonic substructure in accordance with the present invention, disposed inside a stator;

FIG. 5 is an enlarged view of circle B of FIG. 4;

FIG. 6 is an enlarged view of circle C of FIG. 5; and

FIG. 7 illustrates schematically the measured torque-fluctuated curves of the permanent magnet motor with the rotor structure of the invention and the conventional permanent magnet motor in rotations.

### DESCRIPTION OF THE PREFERRED EMBODIMENT

The invention disclosed herein is directed to a rotor structure with suppress harmonic substructure. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

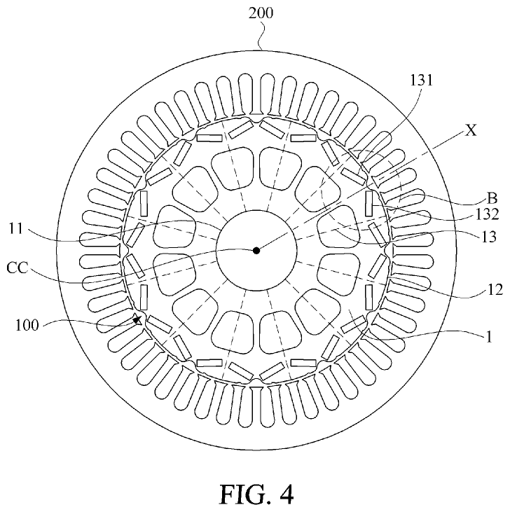

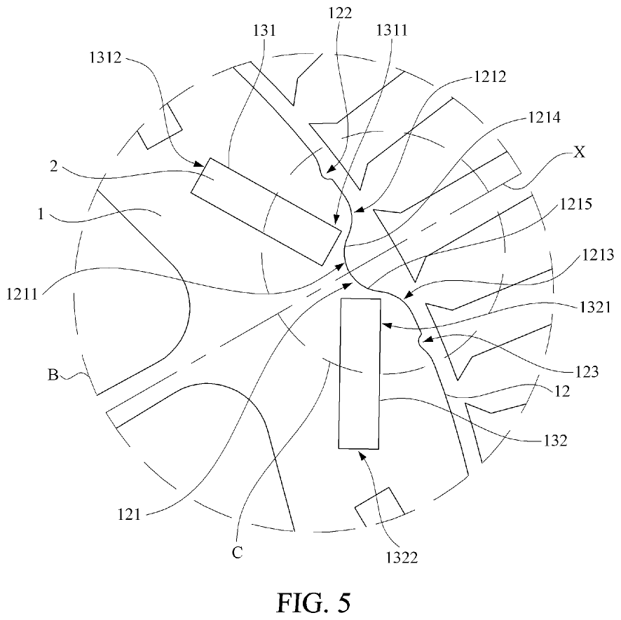

Refer to FIG. 4 and FIG. 5; where FIG. 4 is a schematic planar view of a preferred embodiment of the rotor structure with a suppress harmonic substructure in accordance with the present invention disposed inside a stator, and FIG. 5 is an enlarged view of circle B of FIG. 4. As shown, the rotor structure with a suppress harmonic substructure 100, configured to be disposed inside a stator 200, includes a rotor body 1 and a plurality of magnets 2 (only one labeled in the figure). In operation, the rotor structure 100 utilizes a central shaft (not shown in the figure) to rotate inside the stator 200.

The rotor body 1 has radially oppositely a rotor's inner rim 11 and a rotor's outer rim 12, and both the rotor's inner rim 11 and the rotor's outer rim 12 are extended to surround the same circular center CC. Namely, the rotor's inner rim 11 and the rotor's outer rim 12 are formed as concentric circles. In addition, the rotor body 1 further includes a plurality of magnet-setting areas 13 (twelve in this embodiment, and only one labeled in the figure) located between the rotor's inner rim 11 and the rotor's outer rim 12. These magnet-setting areas 13 are arranged to surround the common circular center CC, and each of the magnet-setting areas 13 is furnished with a first magnet slot 131 and a second magnet slot 132.

As described above, the first magnet slot 131 and the second magnet slot 132 are extended obliquely and symmetrically with respect to a radial axis X passing through the circular center CC. In particular, the first magnet slot 131 has oppositely a first outer end 1311 and a first inner end 1312. Similarly, the second magnet slot 132 has oppositely a second outer end 1321 and a second inner end 1322. The first outer end 1311 and the second outer end 1321 are adjacent to the radial axis X and the rotor's outer rim 12, while the first inner end 1312 and the second inner end 1322 are distant from the radial axis X and the rotor's outer rim 12 (in comparison to the first outer end 1311 and the second outer end 1321, respectively).

In addition, corresponding to each of the magnet-setting area 13s, the rotor's outer rim 12 is furnished with a main cavity 121 (only one labeled in the figure), a first auxiliary cavity 122 (only one labeled in the figure) and a second auxiliary cavity 123 (only one labeled in the figure). In total, the rotor's outer rim 12 would then have twelve said main cavities 121, twelve said first auxiliary cavities 122 and twelve said second auxiliary cavities 123.

Each of the main cavities 121 has a central arc segment 1211, two round corner edges 1212 and 1213 and two straight connecting segments 1214 and 1215. The radial axis X corresponding to the instant magnet-setting area 13 penetrates through the central arc segment 1211 of the local main cavity 121. The two round corner edges 1212 and 1213 are disposed symmetrically to opposite sides of the radial axis X, and the two straight connecting segments 1214 and 1215 are individually formed by extending opposite ends of the central arc segment 1211 to corresponding ends of the two round corner edges 1212 and 1213, respectively. In addition, within each of the magnet-setting areas 13, the first auxiliary cavity 122 and the second auxiliary cavity 123 are disposed to opposite sides of the main cavity 121.

In this embodiment, the central arc segment 1211 and the two round corner edges 1212 and 1213 have the same radius of curvature equal to 5 mm. In addition, the two straight connecting segments 1214 and 1215, though not connected to each other, are to form an opening angle (not shown in the figure), which is 62° in this embodiment, but not limited thereto. In some other embodiments, the opening angle can be an angle ranging between 50° and 70°.

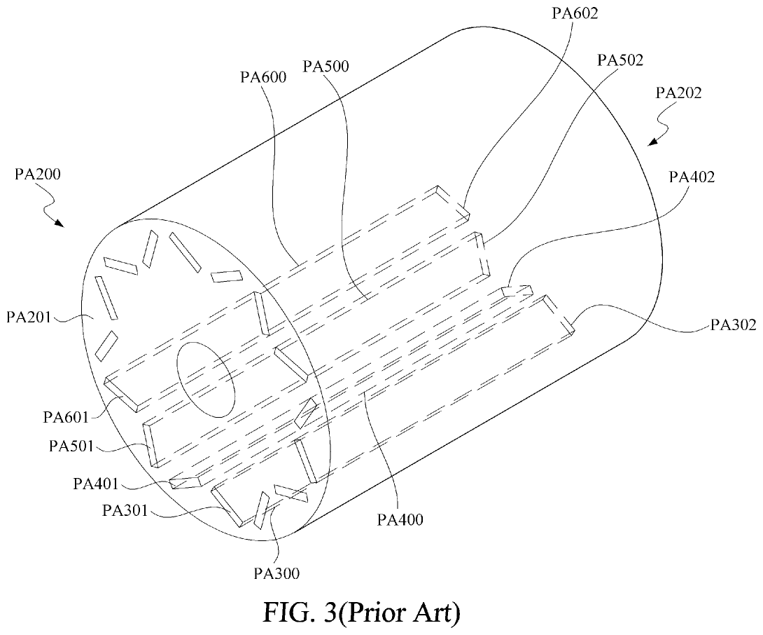

A pair of the magnets 2 are individually disposed into the first magnet slot 131 and the second magnet slot 132 of the corresponding magnet-setting area 13. Please refer to FIG. 3 and the related background description for the polarity arrangement of the magnets 2, and thus details thereabout would be omitted herein.

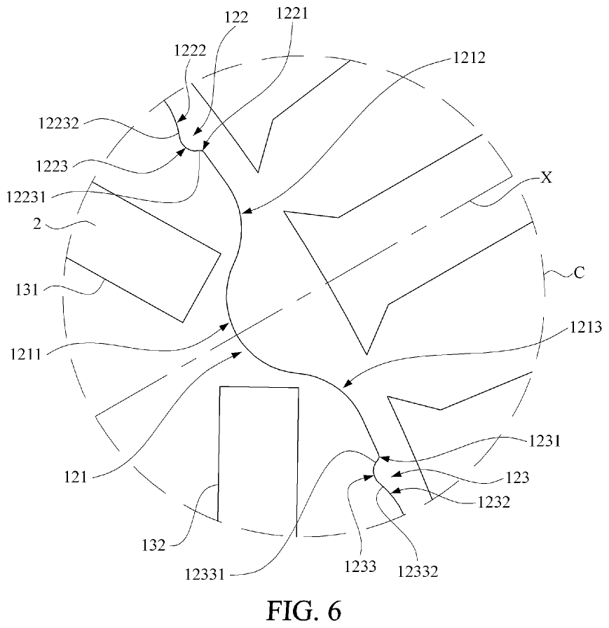

Referring to FIG. 6, an enlarged view of circle C of FIG. 5 is shown. As shown from FIG. 4 to FIG. 6, each of the first auxiliary cavities 122 includes a first convex corner 1221 adjacent to the radial axis X, a second convex corner 1222 away from the radial axis X, and a concave portion 1223 disposed between the first convex corner 1221 and the second convex corner 1222. The first convex corner 1221 has a radius of curvature of 0.3 mm, the second convex corner 1222 has a radius of curvature of 5 mm, and the concave portion 1223 has a radius of curvature of 1 mm. In addition, the concave portion 1223 has a first connecting segment 12231 at one end thereof extending to connect the first convex corner 1221, and a second connecting segment 12232 at another end thereof extending to connect the second convex corner 1222. The first connecting segment 12231 and the second connecting segment 12232 form an angle (not shown in the figure) of 83°.

Similarly, each of the second auxiliary cavities 123 includes a first convex corner 1231 adjacent to the radial axis X, a second convex corner 1232 away from the radial axis X, and a concave portion 1233 disposed between the first convex corner 1231 and the second convex corner 1232. The first convex corner 1231 has a radius of curvature of 0.3 mm, the second convex corner 1232 has a radius of curvature of 5 mm, and the concave portion 1233 has a radius of curvature of 1 mm. In addition, the concave portion 1233 has a first connecting segment 12331 at one end thereof extending to connect the first convex corner 1231, and a second connecting segment 12332 at another end thereof extending to connect the second convex corner 1232. The first connecting segment 12331 and the second connecting segment 12332 form an angle (not shown in the figure) of 83°.

It shall be explained that, from FIG. 4 through FIG. 6, all the radii of curvature and the other angling for the main cavity 121, the first auxiliary cavity 122 or the second auxiliary cavity 123 are schematically provided only, not for exactly demonstrating the angles listed in the specification.

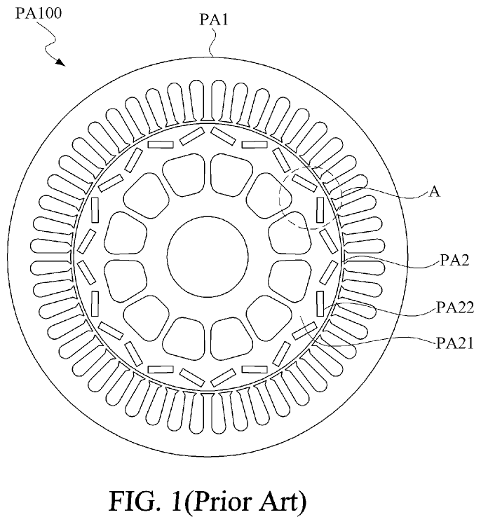

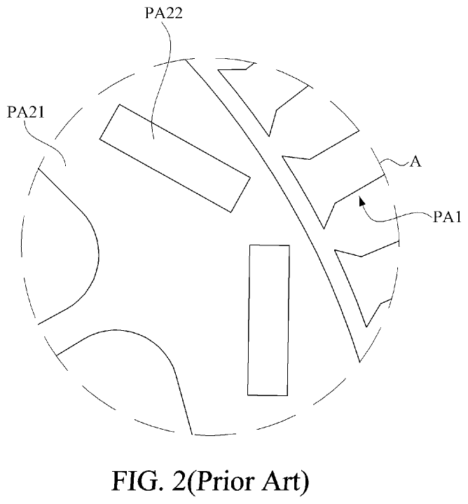

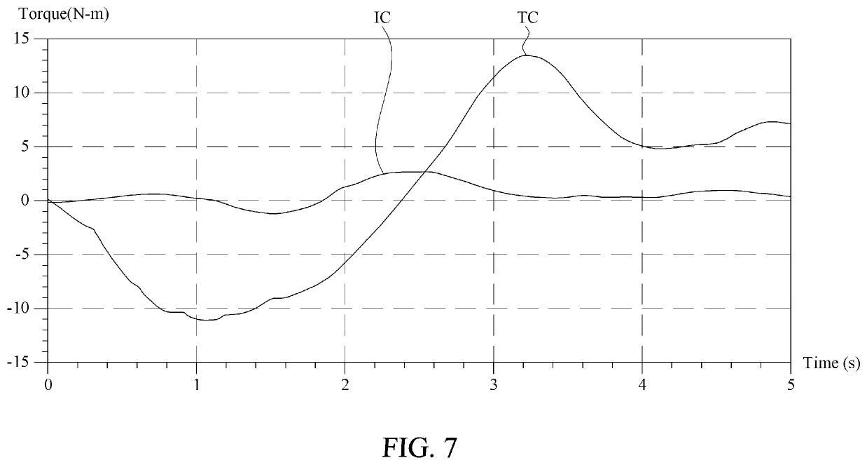

Referring to FIG. 7, the measured torque-fluctuated curves of the permanent magnet motor with the rotor structure of the invention and the conventional permanent magnet motor in rotations are illustrated schematically. As shown in FIG. 1, FIG. 2, FIG. 4 to FIG. 7, the permanent magnet motor equipped with the conventional permanent magnet motor structure PA100 has a torque-fluctuated curve TC, and the permanent magnet motor equipped with the rotor structure with a suppress harmonic substructure 100 of this invention has another torque-fluctuated curve IC.

From curve TC and curve IC in FIG. 7, it is understood that, in operations, the permanent magnet motor equipped with the rotor structure with a suppress harmonic substructure 100 of this invention does have a smaller torque-fluctuation range than the permanent magnet motor equipped with the conventional permanent magnet motor structure PA100 has. Namely, with the main cavities 121, the first auxiliary cavities 122 and the second auxiliary cavities 123, the rotor structure with a suppress harmonic substructure 100 of this invention does contribute to reduce the cogging torque while the permanent magnet motor is rotated.

In summary, in comparison with the conventional permanent magnet motor whose cogging torque forms a significant operation problem, the rotor structure with a suppress harmonic substructure according to this invention provides a plurality of main cavities, a plurality of first auxiliary cavities and a plurality of second auxiliary cavities to the rotor's outer rim, such that, while the rotor structure rotates, the magnetic fields of the magnets in the first magnet slots and the second magnet slots can be effectively extending to the stator, and so the operational cogging torque can be greatly reduced. Namely, with the rotor structure with a suppress harmonic substructure of the invention to equip the permanent magnet motor, the associated operation efficiency can be effectively enhanced.

While the present invention has been particularly shown and described with reference to a preferred embodiment, it will be understood by those skilled in the art that various changes in form and detail may be without departing from the spirit and scope of the present invention.

What is claimed is:

1. A rotor structure with a suppress harmonic substructure, comprising:
a rotor body, furnished with a plurality of magnet-setting areas surrounding a circular center, each of the plurality of magnet-setting areas having a first magnet slot and a second magnet slot, the first magnet slot and the second magnet slot being extended obliquely and symmetrically with respect to a radial axis passing through the circular center, a first outer end of the first magnet slot and a second outer end of the second magnet slot being both disposed adjacent to the radial axis and a rotor's outer rim of the rotor body, a first inner end of the first magnet slot and a second inner end of the second magnet slot being both disposed away from the radial axis and the rotor's outer rim, the rotor's outer rim being furnished with a plurality of main cavities, a plurality of first auxiliary cavities and a plurality of second auxiliary cavities, the radial axis corresponding to one of the plurality of magnet-setting areas penetrating through corresponding one of the plurality of main cavities, one of the plurality of first auxiliary cavities and one of the plurality of second auxiliary cavities in the one of the plurality of magnet-setting areas being disposed to opposite sides of the corresponding one of the plurality of main cavities; and
a plurality of magnets, disposed individually in the first magnet slots and the second magnet slots of the plurality of magnet-setting areas.

2. The rotor structure with the suppress harmonic substructure of claim 1, wherein each of the plurality of first auxiliary cavity includes a first convex corner adjacent to the radial axis, a second convex corner away from the radial axis, and a concave portion disposed between the first convex corner and the second convex corner.

3. The rotor structure with the suppress harmonic substructure of claim 2, wherein the first convex corner has a radius of curvature of 0.3 mm, the second convex corner has a radius of curvature of 5 mm, and the concave portion has a radius of curvature of 1 mm.

4. The rotor structure with the suppress harmonic substructure of claim 2, wherein a first connecting segment is disposed between the first convex corner and the concave portion, a second connecting segment is disposed between the second convex corner and the concave portion, and the first connecting segment and the second connecting segment form an angle of 83°.

5. The rotor structure with the suppress harmonic substructure of claim 1, wherein each of the plurality of main cavities includes a central arc segment and two round corner edges, the radial axis penetrates through the central arc segment, and the two round corner edges are disposed to opposite sides of the central arc segment.

6. The rotor structure with the suppress harmonic substructure of claim 5, wherein the central arc segment has a radius of curvature of 5 mm.

7. The rotor structure with the suppress harmonic substructure of claim 5, wherein each of the two round corner edges has a radius of curvature of 5 mm.

8. The rotor structure with the suppress harmonic substructure of claim 5, wherein each of the plurality of main cavities further includes two straight connecting segments extending individually to connect the two round corner edges, respectively, from the central arc segment.

9. The rotor structure with the suppress harmonic substructure of claim 8, wherein the two straight connecting segments form an opening angle between 50° and 70°.

10. The rotor structure with the suppress harmonic substructure of claim 9, wherein the opening angle is 62°.
